(19) United States
(12) Patent Application Publication
(10) Pub. No.: US 2005/0216305 A1
(43) Pub. Date: Sep. 29, 2005

(54) System for preparation and transmission of specification for customized prostheses

(76) Inventor: Are Funderud, Trondheim (NO)

Correspondence Address: BIRCH STEWART KOLASCH & BIRCH, PO BOX 747, FALLS CHURCH, VA, 22040-0747, US

(21) Appl. No.: 10/504,079

(22) PCT Filed: Feb. 7, 2003
(86) PCT No.: PCT/NO03/00050

§ 371 Date: Mar. 8, 2005

(30) Foreign Application Priority Data
Feb. 8, 2002 (NO) 2002-0647

(51) Int. Cl. G06F 17/60

(52) U.S. Cl. 705/2; 705/3

(57) ABSTRACT

In a system for transmitting specifications for a customized prosthesis, particularly a surgical implant such as a femur prosthesis, an order is first transmitted comprising clinical data for a patient from a client (12) to a server (10). Diagnostic information for the patient is then transmitted from a diagnosis unit (13) to the server (10). The information is further transmitted to a processing unit (15), which generates inetr alia a prosthesis design draft. The draft is transmitted to the server (10) and on to the client (12). A specification based on the draft is transmitted from the client (12) to the server, and manufacturing parameters based on the specification are transmitted to a manufacturing unit (14) for manufacture of the prosthesis. The invention relates to methods and devices that form part of such a system on the server and client sides. The invention brings increased efficiency, reliability and interactivity to the process of specification and manufacture of customized prostheses.

### TECHNICAL FIELD

The present invention relates in general to the manufacture of customised prostheses. Prostheses should be understood to refer to different types of prostheses, particularly surgical implants such as femur prostheses. The invention is illustrated in a non-limiting way in connection with customised femur prostheses for use in hip operations.

More particularly the invention relates to a method for preparation and transmission of specifications for customised prostheses, where the method is implemented by a server computer in a network. The invention also relates to a method for preparation and transmission of specifications for customised prostheses, where the method is implemented by a client workstation in a network. The invention further relates to devices for preparation and transmission of specifications for customised prostheses in the form of a server and client workstation respectively in a network, together with a system for preparation and transmission of specifications for customised prostheses.

### BACKGROUND TO THE INVENTION

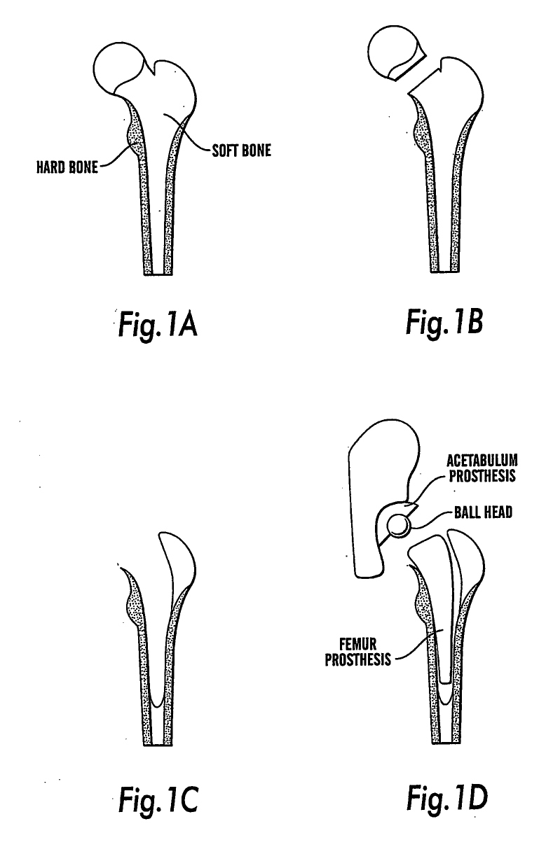

FIG. 1 is a schematic illustration of the sequence (steps A-D) for a conventional hip operation. The sequence consists in firstly (steps A-B) removing the femoral head (caput), before (step C) drilling out a cavity in the pelvic bone. In the pelvic bone (step D) a socket component (“acetabulum prosthesis) is inserted. The interior of the femoral shaft is also rasped out. A femur component (“femur prosthesis”) is inserted in the hollowed-out femoral shaft. A caput prosthesis (“ball head”) is mounted on the femur component. The artificial joint is then assembled.

There is a need for customised prostheses in connection with such hip operations.

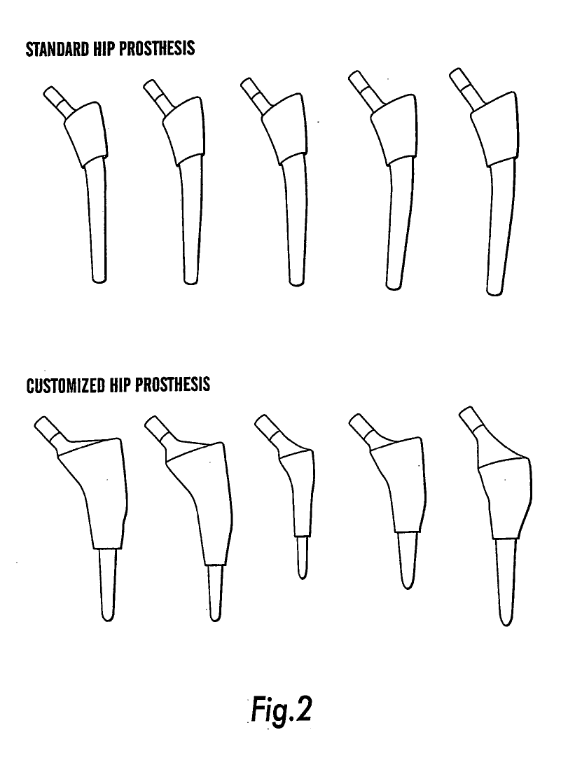

At the top of FIG. 2 are illustrated five examples of standard femur prostheses, and at the bottom five examples of customised femur prostheses. The advantages of individually customised femur prostheses are that intramedullary fitting (i.e. fitting of the part of the prosthesis that is placed inside the medullary cavity) provides stability and optimal load transfer to the bone, and that extramedullary fitting (i.e. fitting of the part of the prosthesis that is to be located outside the medullary cavity) provides the best conditions for achieving a biomechanically optimal hip joint.

According to the prior art, the production process for a customised femur prosthesis is implemented by means of the following simplified sequence:
The doctor (orthopaedist) decides on the use of a customised prosthesis for his patient and fills out an order form requisitioning a CT (Computer Tomography) scan.
The order and CT images are received and a 3D (three-dimensional) design draft is prepared.
The design draft is returned to the orthopaedist, who approves the design draft and selects various parameters. Alternatively, the orthopaedist will reject the design draft and give a reason for his decision. According to the prior art this is implemented by preparing a special case book with reports and moulds and posting it to the orthopaedist.
The final design is formulated and the prosthesis is physically manufactured, packed, sterilised and delivered.

### SUMMARY OF THE INVENTION

The object of the invention is to provide solutions where the communication between the various parts of a production process for prostheses is substantially simplified, where the orthopaedist can work directly on the draft, and where the orthopaedist automatically receives feedback regarding the draft.

A second object is to provide an efficient support tool for an orthopaedist's decision processes in connection with preparation of customised prostheses, particularly in connection with customised femur prostheses for use in hip operations.

The above objects and other advantages are achieved by means of a method as indicated in the following claim 1, a method as indicated in the following claim 5, a device as indicated in the following claim 7, a device as indicated in the following claim 10 and a system as indicated in the following claim 11.

Further objects and other advantages are achieved by means of the features set forth in the dependent claims.

The solution according to the invention includes a number of technical advantages, including a more reliable, fast, efficient and interactive sequence for information exchange in the process of planning, developing and manufacturing a prosthesis.

### DETAILED DESCRIPTION OF THE INVENTION

The invention will now be described in greater detail in the form of an embodiment, with reference to the attached drawings, in which

FIG. 1 illustrates the steps in a hip operation,

FIG. 2 illustrates examples of standardised and customised femur prostheses,

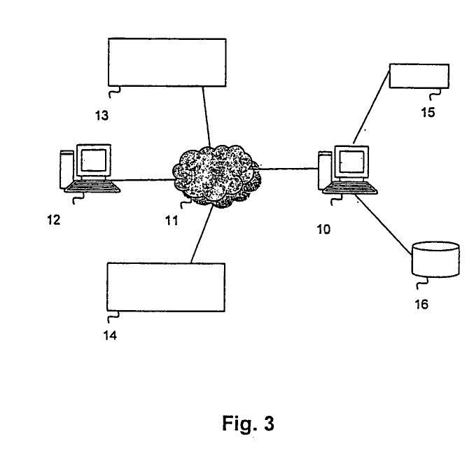

FIG. 3 is a schematic block diagram of a system according to the invention,

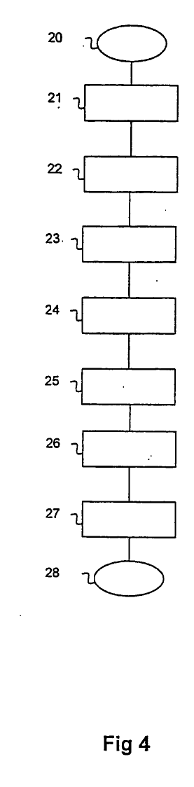

FIG. 4 is a flow chart for a method according to the invention, for implementing a server in the system,

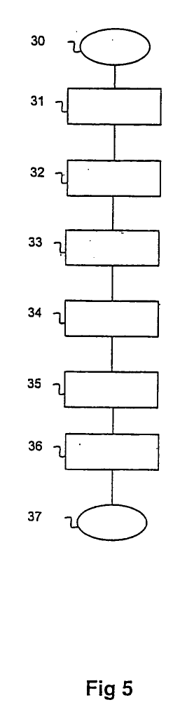

FIG. 5 is a flow chart for a method according to the invention, for implementing a client workstation in the system.

FIGS. 1 and 2 have already been discussed above in the section “Background to the invention”.

FIG. 3 is a schematic block diagram of a system according to the invention.

The system comprises a server computer 10, a client workstation 12, a diagnosis unit 13, a manufacturing unit 14, each of which is connected to a communication network 11 such as the Internet.

The server 10 is further connected to a processing unit 15 and a database 16. As illustrated in FIG. 3, the processing unit 15 and the database 16 are preferably linked to the server 10 locally, i.e. independently of the network 11.

The server 10 comprises a control unit, an input/output unit, a processing unit and a memory unit. The memory unit is arranged to store information, which is transmitted to and from the input and output unit respectively, and the control unit is arranged to control data flow between the input unit, the output unit, the processing unit and the memory unit. The control unit is further arranged to implement a method, which is further illustrated and described in detail below with reference to FIG. 4.

The workstation 12 is intended to be used by an orthopaedist. It comprises a control unit, an input/output unit, a processing unit and a memory unit. The memory unit is arranged to store information transmitted to and from the input and output unit respectively, and the control unit is arranged to control data flow between the input unit, the output unit, the processing unit and the memory unit. The control unit is further arranged to implement a method, which is further illustrated and described in detail below with reference to FIG. 5.

The diagnosis unit 13 is arranged to provide diagnostic information on the patient, in order thereby to provide a digital basis for use in the preparation of the prosthesis design draft. In more specific terms, the diagnosis unit is arranged to prepare diagnostic information based on evaluations carried out on the patient, such as CT images. The diagnosis unit 13 is further arranged to transmit such diagnostic information over the network 11.

The manufacturing unit 14 comprises CAD and CAM systems and production machines for manufacturing the prosthesis. It may also comprise solutions for after-treatment and packing of the prosthesis.

The processing unit 15 is arranged to prepare the draft for the prosthesis design, and to store the order in an order database. Even though the processing unit 15 is illustrated as a separate unit connected to the server 10, the processing unit 15 may advantageously be composed of the processing unit in the server 10, and thereby be an integrated part of the server 10.

Amongst other things, the database 16 contains patient information. The database 16 is preferably arranged to contain patient information, diagnostic information, a draft of the design of the prosthesis, a specification received from the client, manufacturing parameters based on the specification for use by the manufacturing unit in the manufacture of the prosthesis, and status information for orders. The status information for orders permits the orders to be grouped in at least three groups: orders with draft at the preparation stage, orders awaiting specification, orders where the manufacture of the prosthesis is under way. The database can be extended to include two more groups of orders: orders where the prosthesis, associated rasps and operation documentation are delivered to the customer/hospital and orders where the prosthesis has been operated into the patient by an operator (need not be the person making the order) with associated data from the operation, such as type involved, length and diameter of caput prosthesis, type and diameter of acetabulum component used, these data being registered in the system.

FIG. 4 is a flowchart for a method according to the invention, for implementation of the server 10 in the system illustrated in FIG. 3. The method starts at the block 20 and comprises the following data processing steps:

Firstly, an order reception step 21 is implemented, where, by means of the input unit, the server 10 receives an order from a workstation 12 via the network 11. The order comprises information concerning a patient, including clinical data.

A diagnostic information reception step 22 is then implemented, where, by means of the input unit, the server receives diagnostic information for the same patient from the diagnosis unit 13, via the network 11.

The diagnostic information typically comprises digital X-ray images, CT images, etc.

Furthermore, a transmission step 23 is implemented where the received information is transmitted by means of the output unit to a processing unit 15, where an order is generated associated with the received information, a prosthesis design draft and data for positioning prosthesis components based on the received information.

The prosthesis design draft preferably comprises intra and extramedullary parameters. These are parameters associated with the intra and extramedullary parts of the prosthesis. The intramedullary part should be understood to refer to the part of the prosthesis that is fixed to the bone, and is located within the medullary cavity. The extramedullary part should be understood to refer to the part of the prosthesis that protrudes out of the bone, forming a connection with another prosthesis component or another body part.

A draft reception step 24 is then implemented, where, by means of the input unit, the server 10 receives from the processing unit 15 the said prosthesis design draft and said positioning data.

The draft transmission step 25 is then implemented, where the draft is transmitted via the network 11 by means of the input unit to the workstation 12.

Furthermore, a specification reception step 26 is implemented, where a specification is received via the network from the workstation 12 by means of the input unit, where the specification is based on the transmitted draft.

Finally, a parameter transmission step 27 is implemented, where manufacturing parameters based on the specification are transmitted via the network 11 by means of the output unit to a manufacturing unit 14 for the manufacture of the prosthesis.

The method is terminated at the block 28.

FIG. 5 is a flowchart for a method according to the invention, for implementation of the client workstation 12 in the system illustrated in FIG. 3. The method starts at block 30 and comprises the following data processing steps: Firstly, a patient information reception step 31 is implemented, where the workstation 12 receives input from an end user, such as an orthopaedist, concerning information about a patient.

An order preparation step 32 is then implemented, where, by means of the processing unit in the workstation 12, an order is prepared for a prosthesis, where the order comprises information concerning the patient, and where the information comprises clinical data for the patient.

Furthermore, an order transmission step 33 is implemented where the order is transmitted by means of the output unit to the server 10.

A draft reception step 34 is then implemented in the workstation 12, comprising receiving from the server 10 and by means of the input unit, a prosthesis design draft and data for positioning prosthesis components, based on the information in the order and anatomical/biomechanical evaluation from the diagnosis unit 13.

A specification preparation step 35 is then implemented in the workstation 12, where a specification based on the received draft is prepared by means of the processing unit in the workstation 12.

Finally, a specification transmission step 36 is implemented in the workstation 12, comprising transmitting the specification to the server 10 by means of the output unit.

The method preferably also includes a diagnostic information reception step, where diagnostic information is received in the input unit of the workstation 12, based on evaluations performed on the patient, e.g. CT images, for a more precise preparation of customised specifications.

The method implemented by the workstation 12 advantageously comprises an interactive component developed in the form of a Flash or Java component.

The communication between the client workstation 12 and the server 10 takes place via a network 11, such as the Internet.

It will be realised that the invention solves a number of technical problems associated with the problems involved in improving previously known solutions for preparation and transmission of specifications for customised prostheses.

Those skilled in the art will appreciate that many alternatives and variations may be implemented within the scope of the invention as it is defined in the following patent claims and their equivalents.

1-7. (canceled)

8. A method for preparing and transmitting specifications for customised prostheses, for execution by a control unit in a server (10), which further comprises an input/output unit, a processor unit and a memory unit, where the memory unit is arranged to store information, which is transmitted to and from the input and output units respectively, and where the control unit is arranged to control data flow between the input unit, the output unit, the processor unit and the memory unit, the method comprising the following data processing steps:
(21) receiving an order from a client workstation (12) by means of the input unit, where the order comprises information concerning a patient, where the information comprises clinical data,
(22) receiving diagnostic information for the same patient from a diagnostic unit (13) by means of the input unit,
(23) transmitting the received information to a processing unit (15) by means if the output unit, in order to generate therein
an order associated with the received information,
prosthesis design draft and
data for positioning of prosthesis components based on the received information,
(24) receiving from the processing unit (15), by means of the input unit, the said prosthesis design draft and the said positioning data,
(25) transmitting the draft to the client workstation (12) by means of the input unit,
(26) receiving a specification from the client workstation (12) by means of the input unit, where the specifications based on the transmitted draft,
(27) transmitting by means of the output unit manufacturing parameters based in the specification to a manufacturing unit (14) for manufacture of the prosthesis.

9. A method according to claim 8,
where the server (10) is linked to a network (11), and where the client workstation (12) can also be linked to the network, and where the order receipt step (21), the draft transmission step (25) and the specification receipt step (26) are implemented via the network.

10. A method according to claim 9,
where the diagnosis unit (13) is linked to the network (11), and where the diagnostic information receipt step (22) is implemented via the network (11).

11. A method according to claim 9,
where the manufacturing unit (14) is linked to the network (11), and where the parameter transmission step (27) is implemented via the network (11).

12. A method for preparing and transmitting specifications for customised prostheses, for execution by a control unit in a client workstation (12), which further comprises an input/output unit, a processor unit and a memory unit, where the memory unit is arranged to store information, which is transmitted to and from the input and output units respectively, and where the control unit is arranged to control data flow between the input unit, the output unit, the processor unit and the memory unit, the method comprising the following steps:
(31) receiving input from an end user concerning information about a patient,
(32) preparing an order for prosthesis by means of the processor unit, where the order comprises information concerning the patient, and where the information comprises clinical data for the patient,
(33) transmitting the order to a server (10) by means of the output unit,
(34) receiving from the server (19) by means of the input unit a prosthesis design draft and data positioning prosthesis components, based on the information in the order and anatomical/biomechanical evaluation from the diagnosis unit (13),
(35) transmitting the specification to the server (10) by means of the output unit.

13. A method according to claim 12, further comprising the step:
receiving diagnostic information from a diagnosis unit (13) to the input unit, based in evaluations performed on the patient, e.g. CT images, for a more precise preparation of customized specifications.

14. A device for preparing and transmitting specifications for customised prostheses, where the device is in the form of a server (10), comprising a control unit, an input/output unit, a processor unit and a memory unit, where the memory unit is arranged to store information, which is transmitted to and from the input and output units respectively, and where the control unit is arranged to control data flow between the input unit, the output unit, the processor unit and the memory unit, wherein the control unit is further arranged to implement a method as indicated in any one of the claims 8-11.

15. A device according to claim 14,
further comprising a database (16) containing patient information, diagnostic information, the draft, the specification, manufacturing parameters and status information for the orders.

16. A device according to claim 15,
wherein the status information for orders permits the orders to be grouped into at least three groups, including orders with draft at the preparation stage, orders awaiting specification and orders where the development of the prosthesis is under way.

17. A device for preparing and transmitting specifications for customised prostheses, where the device comprises a client workstation (12), comprising an input/output unit, a control unit, a processor unit and a memory unit, where the memory unit is arranged to store information, which is transmitted to and from the input and output units respectively, and where the control unit is arranged to control data flow between the input unit, the output unit, the processor unit and the memory unit,
wherein the control unit is further arranged to implement a method as indicated in any one of the claims 12 or 13.
